(19) United States
(12) Patent Application Publication
(10) Pub. No.: US 2014/0065476 A1
(43) Pub. Date: Mar. 6, 2014

(54) ELECTROLYTE FOR RECHARGEABLE LITHIUM BATTERY AND RECHARGEABLE LITHIUM BATTERY INCLUDING SAME

(71) Applicant: SAMSUNG SDI CO., LTD., Yongin-city (KR)

(72) Inventors: Moon-Sung KIM, Yongin-city (KR); Woo-Cheol SHIN, Yongin-city (KR); Sang-Il HAN, Yongin-city (KR); Jung-Yi YU, Yongin-city (KR); Myung-Hwan JEONG, Yongin-city (KR); Tae-Hyun BAE, Yongin-city (KR); Mi-Hyun LEE, Yongin-city (KR); Myung-Hoon KIM, Yongin-city (KR); Sang-Geun KIM, Yongin-city (KR); So-Hyun HUR, Yongin-city (KR); Ha-Rim LEE, Yongin-city (KR)

(73) Assignee: SAMSUNG SDI CO., LTD., Yongin-city (KR)

(21) Appl. No.: 13/802,373

(22) Filed: Mar. 13, 2013

(30) Foreign Application Priority Data
Sep. 5, 2012 (KR) 10-2012-0098281

(51) Int. Cl. H01M 10/0567

(52) U.S. Cl. CPC H01M 10/0567
USPC 429/207; 429/188; 562/882

(57) ABSTRACT

Disclosed is an electrolyte for a rechargeable lithium battery including boron containing compounds and a rechargeable lithium battery including the same.

### CROSS-REFERENCE TO RELATED APPLICATIONS

This application claims priority to and the benefit of Korean Patent Application No. 10-2012-0098281 filed on Sep. 5, 2012 in the Korean Intellectual Property Office, the disclosure of which is incorporated in its entirety herein by reference.

### BACKGROUND

1. Field

This disclosure relates to an electrolyte for a rechargeable lithium battery and a rechargeable lithium battery including the same.

2. Description of the Related Technology

Rechargeable lithium batteries have recently drawn attention as a power source for small portable electronic devices. They use an organic electrolyte and thereby have twice or more discharge voltage than that of a conventional battery using an alkali aqueous solution and accordingly, have high energy density.

Such rechargeable lithium batteries may include positive active materials and negative active materials. For example, there has been research on using a lithium-transition element composite oxide that can intercalate lithium, such as LiCoO₂, LiMn₂O₄, LiNi₁₋ₓCoₓO₂ (0<x<1), as positive active materials. Traditionally, negative active materials of a rechargeable lithium battery have included various carbon-based materials such as artificial graphite, natural graphite, and hard carbon, which can all intercalate and deintercalate lithium ions.

In addition, a carbonate-based solvent in which a lithium salt is dissolved has been typically used as electrolytes of rechargeable lithium batteries. Recently, an electrolyte prepared by adding a phosphoric acid-based flame retardant as an additive to a mixed solvent of cyclic carbonate and linear carbonate in order to reduce flammability has been used.

However, phosphoric acid-based flame retardants may cause reductive decomposition on the reaction interface of a negative electrode and an electrolyte and decreases of the negative electrode and thus, deteriorates smooth intercalation reaction of lithium ions and may increase battery resistance.

In addition, when a phosphoric acid-based flame retardant is included as a solvent rather than as an additive to the electrolyte, cycle-life characteristic of a battery may be sharply deteriorated.

### SUMMARY

Some embodiments provide an electrolyte for a rechargeable lithium battery, which has improved cycle-life characteristics and storage characteristics at a high temperature.

Another embodiment provides a rechargeable lithium battery including the electrolyte and having improved cycle-life characteristics and storage characteristics at a high temperature.

According to one embodiment, an electrolyte for a rechargeable lithium battery including a compound represented by the following Chemical Formula 1 is provided:

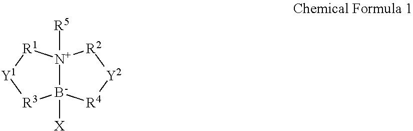

wherein,
Y¹ and Y² are independently —C(O)O—,
R¹, R², R³ and R⁴ are independently a single bond; —O—; or a substituted or unsubstituted C1 to C3 alkylene group,
R⁵ is a substituted or unsubstituted C1 to C6 alkyl group, and
X is a halogen, a substituted or unsubstituted C3 to C8 cycloalkyl group, or a substituted or unsubstituted C2 to C8 unsaturated hydrocarbon group.

In some embodiments, the compound represented by the above Chemical Formula 1 may be represented by the following Chemical Formula 2.

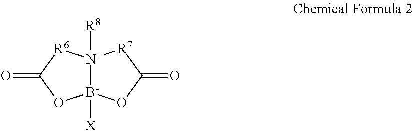

wherein,
R⁶ and R⁷ are independently a single bond; or a substituted or unsubstituted C1 to C3 alkylene group,
R⁸ is a substituted or unsubstituted C1 to C6 alkyl group, and
X is a halogen, a C3 to C8 cycloalkyl group, or a C2 to C8 unsaturated hydrocarbon group.

In some embodiments, the compound represented by the above Chemical Formula 1 may be included in an amount of about 0.001 wt % to 5 wt % based on 100 wt % of the electrolyte.

In some embodiments, the compound represented by the above Chemical Formula 1 may be included in an amount of about 0.001 wt % to 1 wt % based on 100 wt % of the electrolyte.

In some embodiments, the electrolyte for a rechargeable lithium battery may further include a lithium salt and a non-aqueous organic solvent.

In some embodiments, the lithium salt may be included at a concentration of about 0.1M to about 2.0M.

In some embodiments, the lithium salt may include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers of 1 to 20, respectively), LiCl, LiI, and LiB(C₂O₄)₂ (lithium bis(oxalato) borate), or combinations thereof.

In some embodiments, the electrolyte for a rechargeable lithium battery may further include one selected from a flame retardant additive, and an ionic liquid, or combinations thereof.

In some embodiments, the electrolyte may have a viscosity of about 4.0 cp to about 6.0 cp.

According to another embodiment, provided is a rechargeable lithium battery that includes a negative electrode including a negative active material, a positive electrode including a positive active material, and the electrolyte.

Therefore, the present embodiments provide an electrolyte having excellent cycle-life characteristic and storage characteristics at a high temperature and a rechargeable lithium battery including the electrolyte.

### BRIEF DESCRIPTION OF THE DRAWINGS

FIG. 1 is a schematic view showing a rechargeable lithium battery according to one embodiment,

FIG. 2 is a graph showing cycle-life characteristics of rechargeable lithium battery cells according to Examples 1 and 2, and Comparative Examples 1 and 2,

FIG. 3 is a graph showing cycle-life characteristics of rechargeable lithium battery cells according to Examples 3 to 6,

FIG. 4 is a graph showing capacity characteristics of the rechargeable lithium battery cells according to Example 1 and Comparative Example 1,

FIG. 5 is a graph showing storage characteristics at a high temperature of the rechargeable lithium battery cells according to Example 2 and Comparative Example 1,

FIG. 6 is a graph showing properties of the rechargeable lithium battery cells according to Examples 5 and 7 and Comparative Example 1 to determine whether the electrolytes were decomposed or not.

### DETAILED DESCRIPTION

The present disclosure will be described more fully hereinafter with reference to the accompanying drawings, in which exemplary embodiments of this disclosure are shown. However, these embodiments are only exemplary, and the present embodiments are not limited thereto.

As used herein, when other specific definition is not otherwise provided, the term “substituted” may refer to one substituted with at least one substituent selected from a halogen (F, Cl, Br, or I), a hydroxyl group, a nitro group, a cyano group, an imino group (═NH, or ═NR¹⁰¹, wherein R¹⁰¹ is a C1 to C10 alkyl group), an amino group (—NH₂, —NH(R¹⁰²), or —N(R¹⁰³)(R¹⁰⁴), wherein R¹⁰² to R¹⁰⁴ are independently a C1 to C10 alkyl group), an amidino group, a hydrazine group, a carboxyl group, a C 1 to C30 alkyl group; a C1 to C30 alkylsilyl group; C3 to C30 cycloalkyl group; a C2 to C30 heterocycloalkyl group; C6 to C30 aryl group; C2 to C30 heteroaryl group; a C1 to C30 alkoxy group; a C1 to C30 fluoroalkyl group.

In some embodiments, the alkyl group may be a C1 to C30 alkyl group, for example a C1 to C6 alkyl group, a C7 to C10 alkyl group, or a C11 to C20 alkyl group. The alkyl group may be branched, linear, or cyclic.

For example, a C1 to C4 alkyl group refers to one including 1 to 4 carbon atoms in an alkyl chain, for example methyl, ethyl, propyl, iso-propyl, n-butyl, iso-butyl, sec-butyl, or t-butyl.

Typical alkyl groups may include a methyl group, an ethyl group, a propyl group, an isopropyl group, a butyl group, an isobutyl group, a t-butyl group, a pentyl group, a hexyl group, an ethenyl group, a propenyl group, a butenyl group, and the like.

Typical cycloalkyl group may include a cyclopropyl group, a cyclobutyl group, a cyclopentyl group, a cyclohexyl group, and the like.

As used herein the term “aromatic group” refers to a ring or ring system having a conjugated pi electron system and includes both carbocyclic aromatic (e.g., phenyl) and heterocyclic aromatic groups (e.g., pyridine). The term includes monocyclic or fused-ring polycyclic (i.e., rings which share adjacent pairs of atoms) groups provided that the entire ring system is aromatic. Examples may include an aryl group and a heteroaryl group.

As used herein the term “aryl group” refers to a monocyclic or fused ring polycyclic (i.e., rings sharing adjacent pairs of carbon atoms) substituent. In some embodiments, the aryl group may be phenyl.

As used herein the term “heteroaryl group” refers to an aromatic ring or ring system (i.e., two or more fused rings that share two adjacent atoms) that contain(s) one or more heteroatoms, that is, an element other than carbon, including but not limited to, nitrogen, oxygen, phosphorus and sulfur, in the ring backbone. When the heteroaryl is a ring system, every ring in the system is aromatic. In some embodiments, the heteroaryl group may be a fused ring cyclic group where each cycle may include 1 to 3 heteroatoms.

Some embodiments provide an electrolyte for a rechargeable lithium battery including a compound represented by the following Chemical Formula 1:

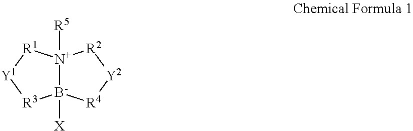

wherein,
Y¹ and Y² are independently —C(O)O—,
R¹, R², R³ and R⁴ are independently a single bond; —O—; or a substituted or unsubstituted C1 to C3 alkylene group,
R⁵ is a substituted or unsubstituted C1 to C6 alkyl group, and
X is a halogen, a C3 to C8 cycloalkyl group, or a C2 to C8 unsaturated hydrocarbon group.

The compound represented by the above Chemical Formula 1 may be included in an electrolyte for a rechargeable lithium battery as an additive, and cycle-life characteristics and storage characteristics at a high temperature of a battery may be improved.

In one embodiment, the compound represented by the above Chemical Formula 1 may be represented by the following Chemical Formula 2.

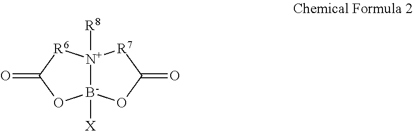

wherein,
R⁶ and R⁷ are independently a single bond; or a substituted or unsubstituted C1 to C3 alkylene group,
R⁸ is a substituted or unsubstituted C1 to C6 alkyl group, and
X is a halogen, a C3 to C8 cycloalkyl group, or a C2 to C8 unsaturated hydrocarbon group. The unsaturated hydrocarbon group may be, for example a C2 to C4 alkenyl group.

In some embodiments, the compound represented by the above Chemical Formula 1 may be represented by the following Chemical Formula 3 or a compound represented by the following Chemical Formula 4.

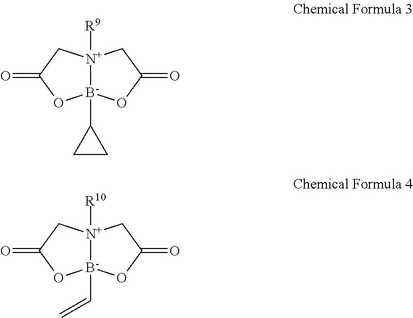

wherein,
R⁹ and R¹⁰ are independently a substituted or unsubstituted C1 to C6 alkyl group.

In some embodiments, the compound represented by the above Chemical Formula 1 may be included in an amount of about 0.001 wt % to about 5 wt % based on 100 wt % of the electrolyte. When the compound represented by the above Chemical Formula 1 within the range is included in an electrolyte, a rechargeable lithium battery including the electrolyte may have excellent cycle-life characteristic and storage characteristics at a high temperature. In some embodiments, the compound represented by the above Chemical Formula 1 may be included in an amount ranging from about 0.1 wt % to about 1 wt %. In some embodiments, the compound represented by the above Chemical Formula 1 may be included in an amount ranging from about 0.1 wt % to about 0.5 wt % based on 100 wt % of the electrolyte.

In some embodiments, the electrolyte may further include one component selected from a flame retardant additive, ionic liquid, and a combination thereof. In general, the flame retardant additive, the ionic liquid, and the like may be added to an electrolyte to secure high stability. However, the flame retardant additive, the ionic liquid, and the like increase viscosity of the electrolyte and thus, deteriorate cycle-life and rate characteristics of a battery. However, the electrolyte includes one selected from the flame retardant additive, the ionic liquid, and a combination thereof along with the compound represented by the above Chemical Formula 1 and thus, may have no problem.

In some embodiments, the flame retardant may include any material known as an electrolyte additive without any particular limit and may be classified into a material trapping oxygen generated under the battery's misuse and another material suppressing generation of an active radical or flammable gas depending on its kind.

The flame retardant may form a coordination bond with lithium ions in an electrolyte and may be oxidized or reduced on the surface of an electrode active material and thus forms a layer thereon. The formed layer may increase interface resistance when a battery is operated for a long term and thus deteriorate cycle-life of the battery. In some embodiments, the compound represented by the above Chemical Formula 1 may suppress formation of the layer on the electrode by electrolyte decomposition.

In some embodiments, the electrolyte may include a compound represented by Chemical Formula 1 as well as a flame retardant and/or ionic liquid and thus, may maintain flammable characteristics and improve battery characteristics, for example, cycle-life and storage characteristics at a high temperature.

In some embodiments, the electrolyte may have a viscosity of about 4.0 cp to about 6.0 cp at a room temperature (e.g., 25° C.).

In some embodiments, the electrolyte may include a non-aqueous organic solvent and a lithium salt.

In some embodiments, the non-aqueous organic solvent serves as a medium for transmitting ions taking part in the electrochemical reaction of a battery.

In some embodiments, the non-aqueous organic solvent may include a carbonate-based, ester-based, ether-based, ketone-based, alcohol-based, or aprotic solvent. In some embodiments, the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like, and the ester-based solvent my include methyl acetate, ethyl acetate, n-propyl acetate, 1,1-dimethylethyl acetate, methylpropinonate, ethylpropinonate, γ-butyrolactone, decanolide, valerolactone, mevalonolactone, caprolactone, and the like. In some embodiments, the ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. In some embodiments, the alcohol-based solvent may include ethanol, isopropyl alcohol, and the like, and the aprotic solvent may include nitriles such as R—CN (where R is a C2 to C20 linear, branched, or cyclic hydrocarbon group including a double bond, an aromatic ring, or an ether bond), amides such as dimethylformamide, dioxolanes such as 1,3-dioxolane, sulfolanes, and the like.

In some embodiments, the non-aqueous organic solvent may be used singularly or in a mixture. When the organic solvent is used in a mixture, the mixture ratio can be controlled in accordance with a desirable battery performance.

In some embodiments, the carbonate-based solvent may be prepared by mixing a cyclic carbonate and a linear carbonate. The cyclic carbonate and the linear carbonate are mixed together in a volume ratio ranging from about 1:1 to about 1:9. When the mixture is used as an electrolyte, the electrolyte performance may be enhanced.

In addition, the non-aqueous organic electrolyte may be further prepared by mixing a carbonate-based solvent with an aromatic hydrocarbon-based solvent. In some embodiments, the carbonate-based and the aromatic hydrocarbon-based solvents may be mixed together in a volume ratio ranging from about 1:1 to about 30:1.

In some embodiments, the aromatic hydrocarbon-based organic solvent may be represented by the following Chemical Formula A:

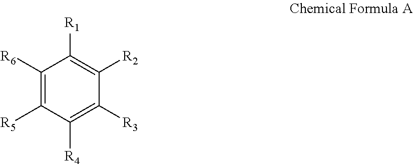

In Chemical Formula A, R₁ to R₆ are independently hydrogen, a halogen, a C1 to C10 alkyl group, a C1 to C10 haloalkyl group, or a combination thereof.

In some embodiments, the aromatic hydrocarbon-based organic solvent may include benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In some embodiments, the non-aqueous electrolyte may further include an additive of vinylene carbonate, an ethylene carbonate-based compound represented by the following Chemical Formula B, or a combination thereof to improve cycle life.

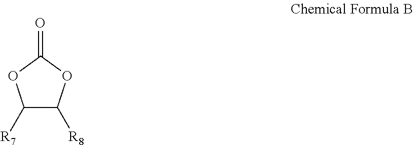

In Chemical Formula B, R₇ and R₈ are independently hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group.

Examples of the ethylene carbonate-based compound include difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The amount of the additive used to improve cycle life may be adjusted within an appropriate range.

The lithium salt is dissolved in an organic solvent and plays a role of supplying lithium ions in a battery, operating a basic operation of the rechargeable lithium battery, and improving lithium ion transportation between positive and negative electrodes therein. In some embodiments, the lithium salt may include at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers of 1 to 20, respectively), LiCl, LiI, LiB(C₂O₄)₂ (lithium bis(oxalato) borate), or a combination thereof. In some embodiments, the lithium salt may be used at a concentration ranging from about 0.1 M to about 2.0 M. When the lithium salt is included at the above concentration range, an electrolyte may have excellent performance and lithium ion mobility due to optimal electrolyte conductivity and viscosity.

According to another embodiment, provided is a rechargeable lithium battery that includes a positive electrode including a positive active material, a negative electrode including a negative active material, and the electrolyte.

A rechargeable lithium battery can be classified into a lithium ion battery, a lithium ion polymer battery, and a lithium polymer battery depending on kinds of a separator and an electrolyte. It also can be classified to be cylindrical, prismatic, coin-type, pouch-type, and the like depending on shape. In addition, it can be bulk type and thin film type depending on size. The structure of these batteries and their manufacturing method are well-known in this field and may not be described in more detail here.

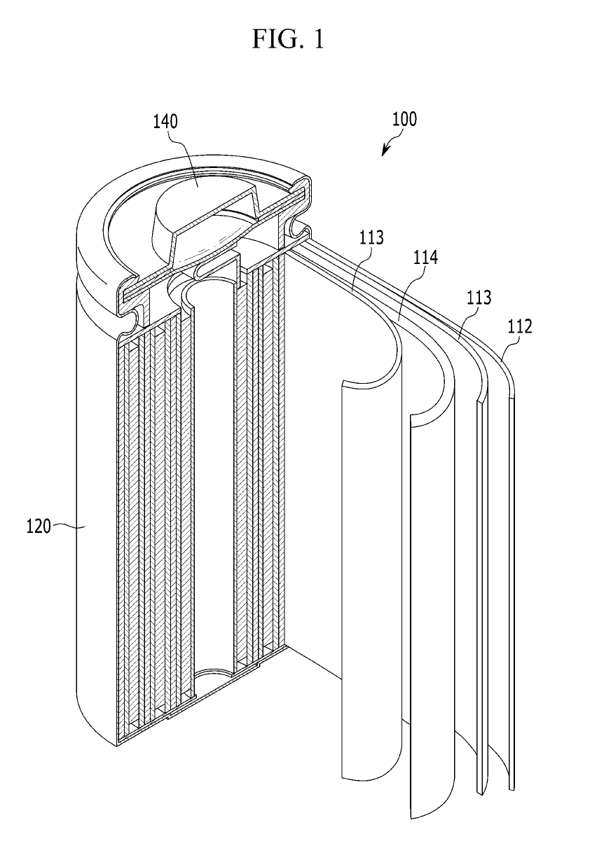

FIG. 1 is an exploded perspective view of a rechargeable lithium battery according to one embodiment.

Referring to FIG. 1, the rechargeable lithium battery 100 is a cylindrical battery including a negative electrode 112, a positive electrode 114, and a separator 113 interposed between the negative electrode 112 and positive electrode 114, and an electrolyte (not shown) impregnating the negative electrode 112, positive electrode 114, and separator 113, a battery case 120 housing the electrode assembly, and a sealing member 140 sealing the battery case. In some embodiments, the rechargeable lithium battery 100 is fabricated by sequentially stacking a negative electrode 112, a positive electrode 114, and separator 113, and spiral-winding them and housing the wound product in the battery case 120.

In some embodiments, the negative electrode includes a current collector and a negative active material layer formed on the current collector, and the negative active material layer includes a negative active material.

In some embodiments, the negative active material includes a material that reversibly intercalates/deintercalates lithium ions, a lithium metal, a lithium metal alloy, a material being capable of doping/dedoping lithium, or a transition metal oxide.

In some embodiments, the material that can reversibly intercalate/deintercalate lithium ions includes a carbon material. In some embodiments, the carbon material may be any generally-used carbon-based negative active material in a lithium ion rechargeable battery. Examples of the carbon material include crystalline carbon, amorphous carbon, and mixtures thereof. In some embodiments, the crystalline carbon may be non-shaped, or sheet, flake, spherical, or fiber shaped natural graphite or artificial graphite. In some embodiments, the amorphous carbon may be a soft carbon, a hard carbon, a mesophase pitch carbonization product, fired coke, and the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, or Sn.

In some embodiments, the material being capable of doping/dedoping lithium may include Si, SiOₓ (0<x<2), a Si—C composite, a Si-Q alloy (wherein Q is selected from an alkali metal, an alkaline-earth metal, Group 13 to Group 16 elements, a transition element, a rare earth element, and a combination thereof, and not Si), Sn, SnO₂, a Sn—C composite, a Sn—R alloy (wherein R is selected from an alkali metal, an alkaline-earth metal, Group 13 to Group 16 elements, a transition element, a rare earth element, and a combination thereof, and not Sn), and the like. In some embodiments, Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, and the like.

In some embodiments, the negative active material layer includes a binder, and optionally a conductive material.

In some embodiments, the binder improves binding properties of negative active material particles with one another and with a current collector. Examples of the binder include polyvinylalcohol, carboxylmethylcellulose, hydroxypropylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

In some embodiments, the conductive material is included to improve electrode conductivity. Any electrically conductive material may be used as a conductive material unless it causes a chemical change. Examples of the conductive material include carbon-based materials such as natural graphite, artificial graphite, carbon black, acetylene black, ketjen black, carbon fibers, and the like; metal-based materials of metal powder or metal fiber including copper, nickel, aluminum, silver; conductive polymers such as polyphenylene derivatives; or a mixture thereof.

In some embodiments, the current collector may include a copper foil, a nickel foil, a stainless steel foil, a titanium foil, a nickel foam, a copper foam, a polymer substrate coated with a conductive metal, or a combination thereof.

In some embodiments, the positive electrode may include a current collector and a positive active material layer on the current collector.

The positive active material includes lithiated intercalation compounds that reversibly intercalate and deintercalate lithium ions. In some embodiments, the positive active material may include a composite oxide including at least one selected from the group consisting of cobalt, manganese, and nickel, as well as lithium. In one embodiment, the following compounds may be used, but is not limited thereto:
LiₐA_{1-b}R_{b}D₂ (0.90≦a≦1.8 and 0≦b≦0.5); LiₐE_{1-b}R_{b}O_{2-c}D_{c} (0.90≦a≦1.8,
0≦b≦0.5 and 0≦c≦0.05); LiE_{2-b}R_{b}O_{4-c}D_{c} (0≦b≦0.5, 0≦c≦0.05);
LiₐNi_{1-b-c}Co_{b}R_{c}D_{α} (0.90≦a≦1.8, 0≦b≦0.5, 0≦c≦0.05 and 0<α≦2);
LiₐNi_{1-b-c}Co_{b}R_{c}O_{2-α}Z_{α} (0.90≦a≦1.8, 0≦b≦0.5, 0≦c≦0.05 and 0<α<2);
LiₐNi_{1-b-c}Co_{b}R_{c}O_{2-α}Z₂ (0.90≦a≦1.8, 0≦b≦0.5, 0≦c≦0.05 and 0<α<2);
LiₐNi_{1-b-c}Mn_{b}R_{c}D_{α} (0.90≦a≦1.8, 0≦b≦0.5, 0≦c≦0.05 and 0<α≦2);
LiₐNi_{1-b-c}Mn_{b}R_{c}O_{2-α}Z_{α} (0.90≦a≦1.8, 0≦b≦0.5, 0≦c≦0.05 and 0<α<2);
LiₐNi_{1-b-c}Mn_{b}R_{c}O_{2-α}Z₂ (0.90≦a≦1.8, 0≦b≦0.5, 0≦c≦0.05 and 0<α<2);
LiₐNi_{b}E_{c}G_{d}O₂ (0.90≦a≦1.8, 0≦b≦0.9, 0≦c≦0.5 and 0.001≦d≦0.1);
LiₐNi_{b}Co_{c}Mn_{d}GeO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001<b≦0.1); LiₐMn₂G_{b}O₄ (0.90≦a≦1.8 and 0.001≦b≦0.1); QO₂; QS₂; LiQS₂;
V₂O₅; LiV₂O₅; LiTO₂; LiNiVO₄; Li_{(3-f)}J₂(PO₄)₃(0≦f≦2); Li_{(3-f)}Fe₂(PO₄)₃(0≦f≦2); and LiFePO₄.

In the above chemical formulae, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, P, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

In some embodiments, the positive active material may include the positive active material with the coating layer, or a compound of the active material and the active material coated with the coating layer. In some embodiments, the coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. In some embodiments, the compound for the coating layer may be either amorphous or crystalline. In some embodiments, the coating element included in the coating layer may be Mg, Al, Co, K, Na, Ca, Si, Ti, V, Sn, Ge, Ga, B, As, Zr, or a mixture thereof. In some embodiments, the coating process may include any conventional processes as long as it does not causes any side effects on the properties of the positive active material (e.g., spray coating, immersing).

In some embodiments, the positive active material layer may include a binder and a conductive material.

The binder improves binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material improves electrical conductivity of a negative electrode. Any electrically conductive material can be used as a conductive agent unless it causes a chemical change. Examples of the conductive material include natural graphite, artificial graphite, carbon black, acetylene black, ketjen black, a carbon fiber, a metal powder or a metal fiber of copper, nickel, aluminum, silver, and the like, and a polyphenylene derivative, which may be used singularly or as a mixture thereof.

In some embodiments, the current collector may be Al but is not limited thereto.

In some embodiments, the negative electrode and positive electrode may be manufactured by a method including mixing an active material, a conductive material, and a binder to prepare an active material composition and coating the composition on a current collector. In some embodiments, the solvent may be N-methylpyrrolidone but it is not limited thereto.

In some embodiments, the electrolyte is as disclosed and described herein.

The separator 113 may include any materials commonly used in the conventional lithium battery as long as separating a negative electrode 112 from a positive electrode 114 and providing a transporting passage for lithium ions. In other words, the separator 113 may be made of a material having a low resistance to ion transportation and an excellent impregnation for an electrolyte. For example, the material may be selected from glass fiber, polyester, polyethylene, polypropylene, polytetrafluoroethylene (PTFE), or a combination thereof. It may have a form of a non-woven fabric or a woven fabric. For example, a polyolefin-based polymer separator such as polyethylene, polypropylene or the like is mainly used for a lithium ion battery. In order to ensure the heat resistance or mechanical strength, a coated separator including a ceramic component or a polymer material may be used. Selectively, it may have a mono-layered or multi-layered structure.

Hereinafter, the embodiments are illustrated in more detail with reference to examples. However, the following are exemplary embodiments and are not limiting.

### EXAMPLES

### SYNTHESIS EXAMPLES

### Synthesis Example 1

A compound represented by the following Chemical Formula 5 was synthesized according to the following Reaction Scheme 1 according to the procedure of Burke et al. Org. Lett., 2010, 12(10): 2314-2317 incorporated in its entirety herein by reference.

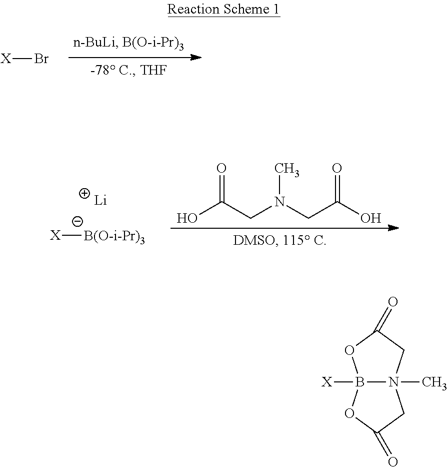

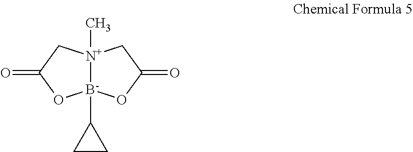

Cyclopropyl bromide (8.6 mmol), triisopropylborate (2.4 mL, 10 mmol), and tetrahydrofuran (THF, 17 mL) were put in a 50 mL flask, and n-butyllithium (8.5 mmol of a hexane solution with a concentration of 2.5M) (ca. 0.25 mL/min) was added thereto over 1 hour in a dropwise fashion at −78° C. The mixture was agitated at 23° C. for 3 hours, providing borate intermediate. N-Methyliminodiacetic acid (2.151 g, 14.62 mmol) and dimethylsulfoxide (DMSO, 17 mL) were put in a 3-necked flask, and the borate intermediate was slowly added thereto in a dropwise fashion. The mixture was agitated at 115° C. for about 1 hour. The agitated mixture was cooled down to 50° C. and the mixture was placed under reduced pressure to remove the DMSO therein. Subsequently, the mixture was cooled down to room temperature. Then, the mixtue was filtered through celite and the crude material was purified by column chromatography, obtaining a compound represented by the following Chemical Formula 5.

### Synthesis Example 2

A compound represented by the following Chemical Formula 6 was synthesized according to the same method as Synthesis Example 1 except for using vinyl bromide instead of cyclopropyl bromide.

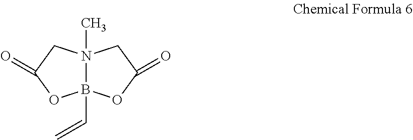

### BATTERY FABRICATION EXAMPLES

### Example 1

A rechargeable lithium battery cell was fabricated using lithium nickel cobalt manganese-based oxide (LiNi_{0.4}Co_{0.3}Mn_{0.4}O₂) as a positive active material and graphite as a negative active material to fabricate electrodes and inserting a polyethylene (PE) film separator between the electrodes. Herein, an electrolyte was prepared by EC (ethylene carbonate), EMC (ethylmethyl carbonate), DMC (dimethyl carbonate), and a compound represented by mixing the following Chemical Formula 7 in a volume ratio of 27:36:27:10, adding LiPF₆ to be 1.3M of a concentration thereto, and adding the compound according to Synthesis Example 1 to be 0.5 wt % thereto.

The negative and positive electrodes and the separator were spirally wound and compressed and then, housed in a coin-type battery (2032 cell; coin full cell) case, and the electrolyte was inserted therein, completing a rechargeable lithium battery cell.

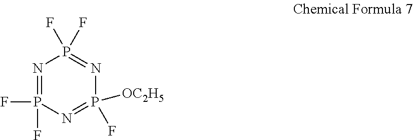 [SMILES: CCOP1(F)=NP(F)(F)=NP(F)(F)=N1]

### Example 2

A rechargeable lithium battery cell was fabricated according to the same method as Example 1 except for using the compound according to Synthesis Example 2 instead of the compound according to Synthesis Example 1.

### Example 3

Electrodes were fabricated using lithium nickel cobalt manganese-based oxide (LiNiCoMnO₂) as a positive active material and graphite as a negative active material, and a polyethylene (PE) film separator was inserted between the electrodes. Herein, an electrolyte was prepared by mixing EC (ethylene carbonate), EMC (ethylmethyl carbonate), and DMC (dimethyl carbonate) in a volume ratio of 4:3:3, adding LiPF₆ in a concentration of 1.3M thereto, and adding the compound according to Synthesis Example 1 to be 0.1 wt % thereto.

The negative and positive electrodes and the separator were spirally wound and compressed and then, housed in a coin-type battery (2032 cell; coin full cell) case, and the electrolyte was inserted therein, completing a rechargeable lithium battery cell.

### Example 4

A rechargeable lithium battery cell was fabricated according to the same method as Example 3 except for using 0.2 wt % of the compound according to Synthesis Example 1.

### Example 5

A rechargeable lithium battery cell was fabricated according to the same method as Example 3 except for preparing an electrolyte including 0.5 wt % of the compound according to Synthesis Example 1.

### Example 6

A rechargeable lithium battery cell was fabricated according to the same method as Example 3 except for using an electrolyte including 1.0 wt % of the compound according to Synthesis Example 1.

### Example 7

A rechargeable lithium battery cell was fabricated according to the same method as Example 3 except for using an electrolyte including 0.5 wt % if the compound according to Synthesis Example 2 instead of the compound according to Synthesis Example 1.

### Comparative Example 1

A rechargeable lithium battery cell was fabricated according to the same method as Example 3 except for using no compound according to Synthesis Example 1.

### Comparative Example 2

A rechargeable lithium battery cell was fabricated according to the same method as Example 1 except for using no compound according to Synthesis Example 1.

### Analysis

### Evaluation Example 1

The rechargeable lithium battery cells according to Examples 1 to 6, and Comparative Examples 1 and 2 were evaluated regarding cycle-life characteristic.

The cycle-life characteristics were evaluated based on specific capacity change depending on the cycles. The evaluation was performed by charging and discharging the rechargeable lithium battery cells at 1C within a voltage ranging from 2.8V to 4.2 V for 50 cycles at 45° C., and then charging an discharging the cells at 1C within a voltage ranging from 2.8V to 4.2 V for 105 cycles at 25° C.

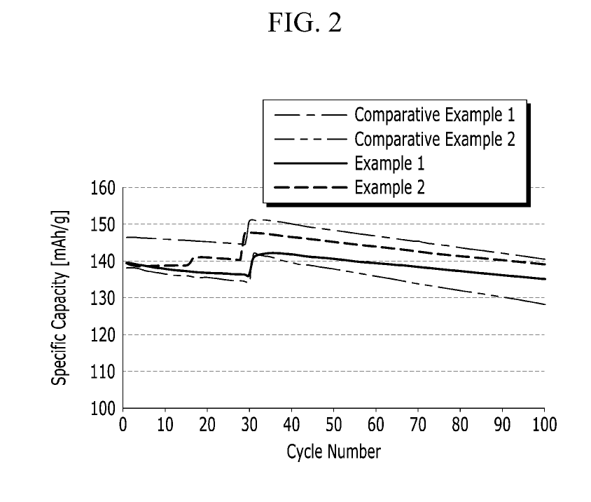

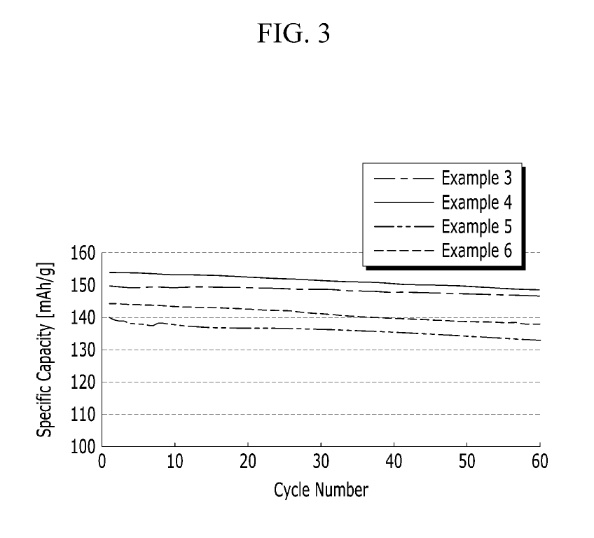

The data from the analysis is shown in FIGS. 2 and 3.

FIG. 2 is a graph showing cycle-life characteristic of the rechargeable lithium battery cells according to Examples 1 to 2, and Comparative Examples 1 to 2, and FIG. 3 is a graph showing cycle-life characteristic of the rechargeable lithium battery cells according to Examples 3 to 6.

Referring to FIG. 2, the rechargeable lithium battery cells according to Comparative Example 2 with the flame retardant additive represented by Formula 7, exhibited surprisingly deteriorated cycle-life characteristics, compared to the rechargeable lithium battery cell according to Comparative Example 1 using the conventional electrolyte. It can be shown that such a deterioration of the cycle-life characteristics can be prevented from the addition of the compounds represented by Formulas 5 and 6, according to Examples 1 and 2.

Furthermore, referring to FIG. 3, the rechargeable lithium battery cells according to Examples 3 to 6 almost completely maintained specific capacity after the charge and discharge over many cycles, and especially, the rechargeable lithium battery cells using the compound represented by Formula 5 of 0.1 wt % and 0.2 wt %, respectively exhibited more improved cycle-life characteristics. Based on the result, the rechargeable lithium battery cells according to Examples 1 to 6 had excellent cycle-life characteristic.

### Evaluation Example 2

The rechargeable lithium battery cells according to Example 2 and Comparative Example 1 were evaluated regarding capacity characteristics. The rechargeable lithium battery cells were charged and discharged with 1C at a voltage ranging from 2.8V to 4.2V at the 200th cycle at 45° C.

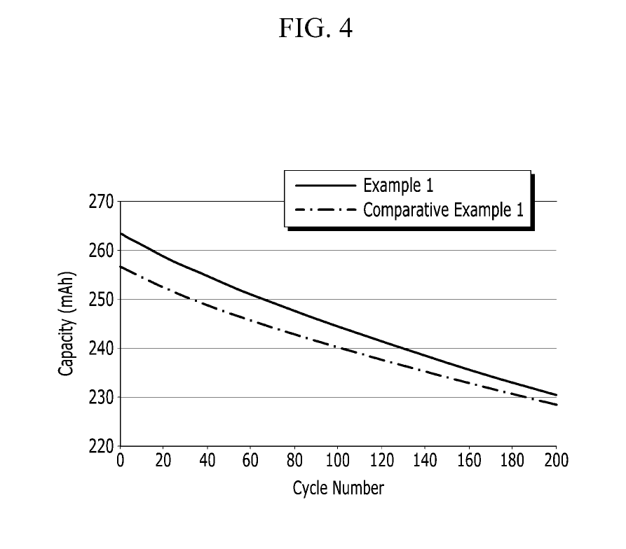

FIG. 4 is a graph showing capacity characteristics of the rechargeable lithium battery cells according to Example 1 and Comparative Example 1.

Referring to FIG. 4, the rechargeable lithium battery cell according to Example 1 had excellent capacity compared with the one according to characteristic Comparative Example 1.

### Evaluation Example 3

The rechargeable lithium battery cells according to Example 2 and Comparative Example 1 were evaluated regarding storage characteristics at a high temperature. The evaluation was proceeded by performing an initial formation process of charging and discharging the rechargeable lithium battery cells at 0.2C at a voltage ranging from about 2.8V to 4.2 and allowing them to stand at 60° C. for 30 days.

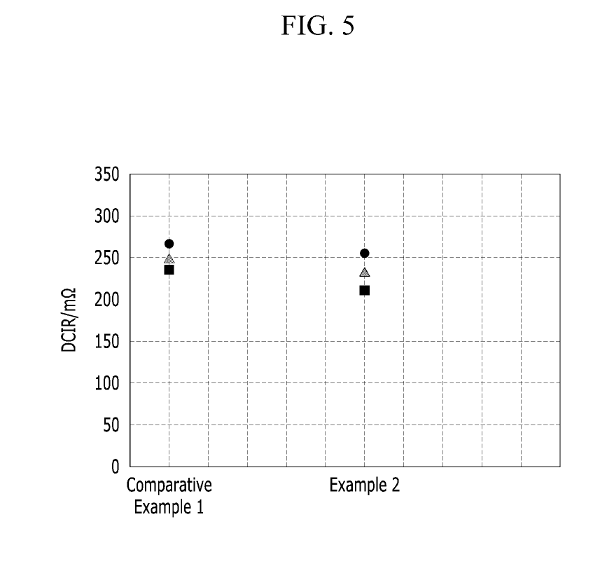

FIG. 5 is a graph showing storage characteristics at a high temperature of the rechargeable lithium battery cells according to Example 2 and Comparative Example 1 ( ▪: resistance after the cells were allowed to stand at 60° C. for 10 days; ▴: resistance after 20 days; : resistance after 30 days).

Referring to FIG. 5, the rechargeable lithium battery cell according to Example 2 exhibited lower resistance than that according to Comparative Example 1 so that the rechargeable lithium battery cell according to Example 2 had excellent output characteristic compared with the one according to Comparative Example 1 and thus, excellent storage characteristics at a high temperature.

### Evaluation Example 4

The rechargeable lithium battery cells according to Examples 5 and 7 and Comparative Example 1 were evaluated regarding electrolyte decomposition. The evaluation was performed by discharging the rechargeable lithium battery cells at 0.1C at 0.01V to 4.2V at the 1st cycle.

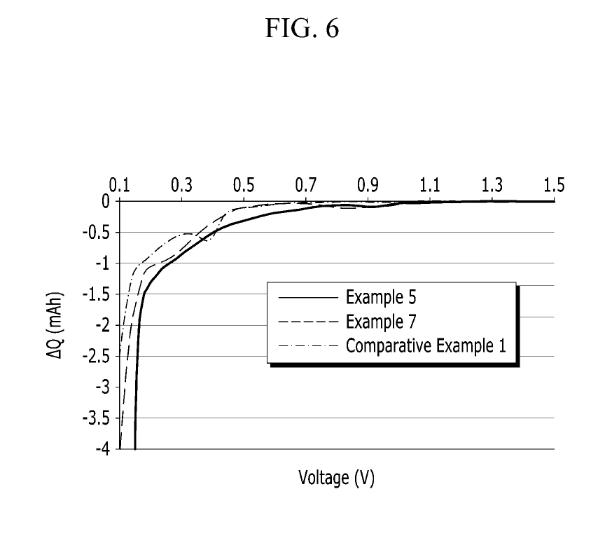

The data from the analysis is shown in FIG. 6.

FIG. 6 is a graph showing whether the electrolytes of the rechargeable lithium battery cells according to Examples 5 and 7 and Comparative Example 1 were decomposed or not.

Referring to FIG. 6, in the electrolytes of the rechargeable lithium battery cells according to Examples 5 and 7, EC was not decomposed, while in the electrolyte of the rechargeable lithium battery cell according to Comparative Example 1, EC was decomposed. This is evident from FIG. 6 that the cells according to Examples 5 and 7 had broad peaks derived from EC at about 0.1V to about 0.4V, but the cell according to Comparative Example 1 had no peak. Therefore, the rechargeable lithium battery cells according to Examples 5 and 7 had a stable film and showed that the decomposition of the EC was suppressed.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An electrolyte for a rechargeable lithium battery comprising a compound represented by the following Chemical Formula 1: 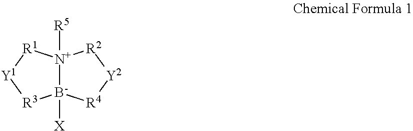
wherein,
Y¹ and Y² are independently —C(O)O—,
R¹, R², R³ and R⁴ are each independently a single bond; —O—; or a substituted or unsubstituted C1 to C3 alkylene group,
R⁵ is a substituted or unsubstituted C1 to C6 alkyl group, and
X is a halogen, a substituted or unsubstituted C3 to C8 cycloalkyl group, or a substituted or unsubstitutedC2 to C8 unsaturated hydrocarbon group.

2. The electrolyte for a rechargeable lithium battery of claim 1, wherein the compound represented by the above Chemical Formula 1 is represented by the following Chemical Formula 2: 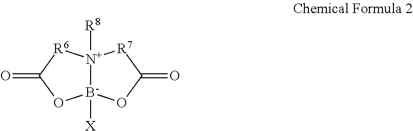
wherein,
R⁶ and R⁷ are independently a single bond; or a substituted or unsubstituted C1 to C3 alkylene group,
R⁸ is a substituted or unsubstituted C1 to C6 alkyl group, and
X is a halogen, a C3 to C8 cycloalkyl group, or a C2 to C8 unsaturated hydrocarbon group.

3. The electrolyte for a rechargeable lithium battery of claim 1, wherein the compound represented by the above Chemical Formula 1 is included in an amount of about 0.001 wt % to 5 wt % based on 100 wt % of the electrolyte.

4. The electrolyte for a rechargeable lithium battery of claim 3, wherein the compound represented by the above Chemical Formula 1 is included in an amount of about 0.001 wt % to 1 wt % based on 100 wt % of the electrolyte.

5. The electrolyte for a rechargeable lithium battery of claim 1, further comprising a lithium salt and a non-aqueous organic solvent.

6. The electrolyte for a rechargeable lithium battery of claim 5, wherein the lithium salt is included at a concentration of about 0.1M to about 2.0M.

7. The electrolyte for a rechargeable lithium battery of claim 5, wherein the lithium salt comprises at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein x and y are natural numbers of 1 to 20, respectively), LiCl, LiI, and LiB(C₂O₄)₂ (lithium bis(oxalato) borate).

8. The electrolyte for a rechargeable lithium battery of claim 1, further comprising at least one selected from a flame retardant additive and ionic liquid.

9. The electrolyte for a rechargeable lithium battery of claim 1, wherein the electrolyte has a viscosity of about 4.0 cp to about 6.0 cp.

10. A rechargeable lithium battery, comprising:
a negative electrode including a negative active material;
a positive electrode including a positive active material; and an electrolyte comprising a compound represented by the following Chemical Formula 1: 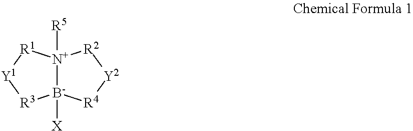
wherein,
Y¹ and Y² are independently —C(O)O—,
R¹, R², R³ and R⁴ are each independently a single bond; —O—; or a substituted or unsubstituted C1 to C3 alkylene group,
R⁵ is a substituted or unsubstituted C1 to C6 alkyl group, and
X is a halogen, a substituted or unsubstituted C3 to C8 cycloalkyl group, or a substituted or unsubstitutedC2 to C8 unsaturated hydrocarbon group.

11. The battery of claim 10, wherein the compound represented by Chemical Formula 1 is represented by the following Chemical Formula 2: 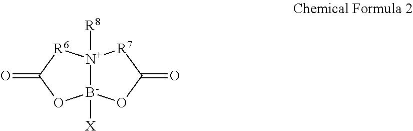
wherein,
R⁶ and R⁷ are independently a single bond; or a substituted or unsubstituted C1 to C3 alkylene group,
R⁸ is a substituted or unsubstituted C1 to C6 alkyl group, and
X is a halogen, a C3 to C8 cycloalkyl group, or a C2 to C8 unsaturated hydrocarbon group.

12. The battery of claim 10, wherein the compound represented Chemical Formula 1 is included in an amount of about 0.001 wt % to 5 wt % based on 100 wt % of the electrolyte.

13. The battery of claim 12, wherein the compound represented by the above Chemical Formula 1 is included in an amount of about 0.001 wt % to 1 wt % based on 100 wt % of the electrolyte.

14. The battery of claim 10, wherein the electrolyte further comprises a lithium salt and a non-aqueous organic solvent.

15. The battery of claim 14, wherein the lithium salt is included at a concentration of about 0.1M to about 2.0M.

16. The battery of claim 14, wherein the lithium salt comprises at least one supporting salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂) (C_{y}F_{2y+1}SO₂) (wherein x and y are natural numbers of 1 to 20, respectively), LiCl, LiI, and LiB(C₂O₄)₂ (lithium bis(oxalato) borate).

17. The battery of claim 10, wherein the electrolyte further comprises at least one selected from a flame retardant additive and ionic liquid.

18. The battery of claim 10, wherein the electrolyte has a viscosity of about 4.0 cp to about 6.0 cp.
